(19) United States
(12) Patent Application Publication
(10) Pub. No.: US 2006/0026282 A1
(43) Pub. Date: Feb. 2, 2006

(54) Method and apparatus for supporting a system management

(75) Inventors: Yumiko Seki, Tokyo (JP); Masami Kameda, Tokyo (JP); Takeshi Fujii, Yokohama-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi Software Engineering Co., Ltd., Yokohama (JP)

(21) Appl. No.: 11/235,797

(22) Filed: Sep. 26, 2005

Related U.S. Application Data
(63) Continuation of application No. 10/055,490, filed on Oct. 19, 2001.

(30) Foreign Application Priority Data
Feb. 19, 2001 (JP) 2001-041120

(51) Int. Cl. G06F 15/173

(52) U.S. Cl. 709/224

(57) ABSTRACT

A decentralized system managing method is provided for adapting a decentralized service changing day by day without having to recreate the overall existing application and for optimally executing the application without having to burden the overhead of the network load. The managing method is arranged to obtain the log information in executing the program, accumulate and work the log information, and present the result to the user. At a time, the managing method is served to create and issue an improving instruction for making the application execution the most approximate according to the optimization rule instructed by the user.

### CROSS-REFERENCES TO RELATED APPLICATIONS

This a continuation application of pending U.S. patent application Ser. No. 10/055,490, filed Oct. 19, 2001, which is herein incorporated by reference for all purposes.

### BACKGROUND OF THE INVENTION

The present invention relates to a method and an apparatus for supporting promotion and management of services to be executed by plural computers and programs to be executed by each computer.

As a conventional service providing system having a computer for providing a service connected in a network, for example, the technology has been disclosed in JP-A-11-102336. Herein, the technology has been disclosed in which through the use of the communication connecting log information in executing a client program, a server computer is determined which performs a maximum number of connections in executing the program and the program is moved to the determined server computer for executing the program.

### BRIEF SUMMARY OF THE INVENTION

The foregoing prior art has been concerned with the arrangement in which the load burdened on the server computer is lessened through the disclosed content and the connecting times of the network and the network traffics are reduced.

On the other hand, it is necessary to execute the overall system optimally so that the target service may be provided more quickly in response to the request and the reliability to the response for the request may be enhanced. For this purpose, it is also necessary to distribute the request for the service and determine the scheduling of the services to be executed by the computers. This point of view has not been disclosed in the foregoing prior art.

In the case that the request for the service is distributed and the scheduling of the services to be executed by the computers is carried out, the change of the program is made less frequent. It is an object of the present invention to provide a decentralized system and a method and an program for managing the system which are arranged to carry out the optimal execution in compliance to the distributed service changing day by day.

In carrying out the object, according to an aspect of the invention, a system is arranged to set a plurality of promotion rules for defining promotion of a service and a plurality of conditions for executing each promotion rule, collect log information generated by execution of the service from each computer, and, if the collected log information meets the condition, execute the promotion rule corresponding with this condition.

As described above, the promotion of the service is determined on the log information. Hence, the system enables to correspond with the service request changing day by day so that the system itself may be promoted optimally.

### BRIEF DESCRIPTION OF THE DRAWINGS

FIG. 1 is a diagram showing a configuration of an overall system;

FIG. 2 is a view showing an arrangement of a storage unit included in a system management supporting section;

FIG. 3 is a view showing an arrangement of a storage unit included in an application server;

FIG. 4 is a view showing an arrangement of a storage unit included in a job executing server;

FIG. 5 is a flowchart showing a flow of a log detecting unit;

FIG. 6 is a flowchart showing a flow of a log data extracting unit;

FIG. 7 is a view showing an example of a log form rule;

FIG. 8 is a flowchart showing an extracted data processing unit;

FIG. 9 is a view showing an example of a multi-dimensional table;

FIG. 10 is a flowchart showing a flow of an analyzing process;

FIG. 11 is a view showing an example of a view display table;

FIG. 12 is a view showing an example of a view display table;

FIGS. 13A and 13B are views showing an example of a view presentation;

FIGS. 14A and 14B are views showing an example of a view presentation;

FIGS. 15A and 15B are views showing an example of a view presentation;

FIGS. 16A and 165B are views showing an example of a view presentation;

FIG. 17 is a flowchart showing a flow of an execution rule generating process;

FIG. 18 is a view showing an example of optimization rules;

FIG. 19 is a flowchart showing a process of optimal execution;

FIG. 20 is a flowchart showing a flow of a process of reading log information;

FIG. 21 is a flowchart showing a flow of a scheduling process;

FIG. 22 is a view showing an example of a presentation of a scheduling process to a user;

FIGS. 23A and 23B are views showing an example of a list of log information collecting destinations;

FIG. 24 is a view showing an example of a rule in the case of a view presentation;

FIG. 25 is a view showing an example of a rule in the case of a view presentation;

FIG. 26 is a view showing an example of a rule in the case of a view presentation;

FIG. 27 is a view showing an example of a rule in the case of a view presentation; and

FIGS. 28A and 28B are views showing an example of an optimization instruction table.

### DETAILED DESCRIPTION OF THE INVENTION

Hereafter, an embodiment of the invention will be described with reference to the appended drawings.

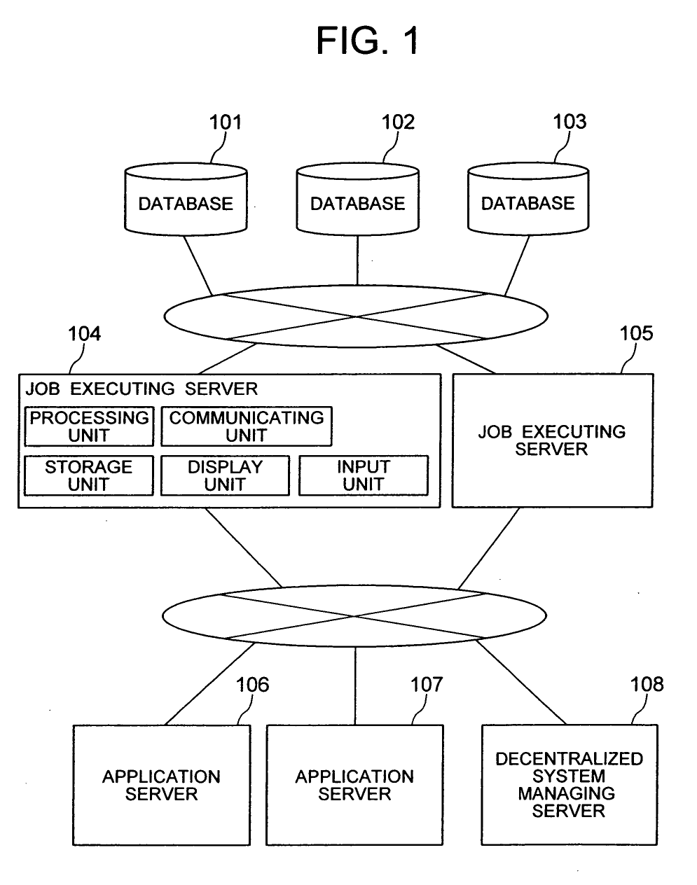

FIG. 1 shows a system configuration according to the embodiment of the invention. The present system includes a plurality of databases 101 to 103, a plurality of job executing servers 104 and 105, a plurality of application servers 106 and 107, and a decentralized system management server 108, all of which are connected in a network. The application server 106 or 107 includes a plurality of application programs and operates to store data in the database if necessary, update the data, or send an instruction for reading the data to the job executing server 104 or 105. The job executing server 104 or 105 makes access to the databases 101 to 103 for storing, updating and reading the data in accordance with the instruction sent from the application server 106 or 107. The decentralized system managing server 108 operates to read log information from the job executing servers 104, 105 and the application servers 106, 107 and manage the promotion of the job executing server or the application server. Concretely, the decentralized system managing server 108 operates to generate the promotion rule for controlling the scheduling of jobs and applications within the job executing server or the application server and controlling the job executing server to be accessed by the application server.

The job executing server is made up of a processing unit such as a CPU, a communicating unit for connecting with a network, a storage unit such as an optical disk or a magnetic disk, a display unit such as a CRT or a liquid crystal display, and an input unit such as a keyboard or a mouse. In addition, the application server or the decentralized management server is made up of the same components as described above.

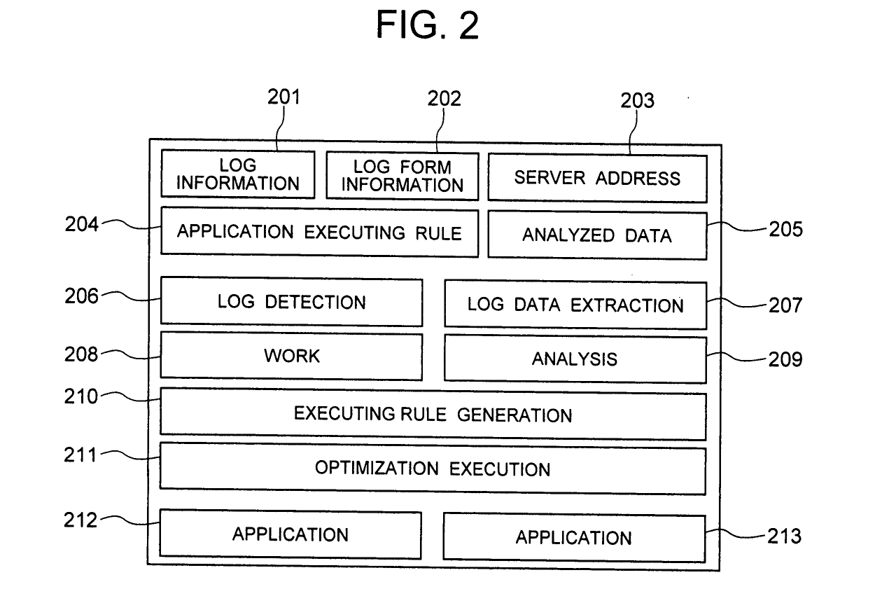

FIG. 2 shows a main data or program stored in the storage unit included in the decentralized system management server 108.

The log information 201 and the log form information 202 store log information and log form information of the job executing servers 104 and 105 and the application servers 106 and 107. The server address 203 stores addresses of the job executing server and the application server. A numeral 204 denotes an application execution rule which stores the promotion rules of the job executing server or the application server and the promotion rules of the job program or the application program of the job executing server or the application server. A numeral 205 denotes analyzed data, which is the result of analyzing the log information 201. The analyzed data includes the promoting results of the job executing server and the application server and the promoting results of the program.

A log detecting process 206 is a program for obtaining the log information and the log form information from the job executing server and the application server. A log data extracting process 207 is a program for extracting the log information according to the log form information. A working process 208 is a program for editing and working the extracted log data. An analyzing process 209 is a program for analyzing the edited and analyzed result or displaying the analyzed result on a display unit. An execution rule generating process 210 is a program for generating optimization rules (promotion rule) for performing the optimal execution based on the analyzed result presented thereto. An optimization execution process 211 is a program for selecting a control command for controlling the job executing server or the application server according to the generated optimization rules and the log information and then sending the control command. As described above, the decentralized system managing server 108 is served to collect log information from the job executing servers 104, 105 and the application servers 106, 107 and generate the optimization rules for controlling the job program or the application program. Further, the server 108 is also served to send the control command according to the generated optimization rules and the log information for the purpose of directly controlling the promotion of the job executing servers 104, 105 and the application servers 106, 107. This configuration makes it possible for the job executing server or the application server to eliminate a special program for executing the optimization rules.

In place, the special program for executing the optimization rules may be stored in the job executing server or the application server, while the decentralized system managing serer may be served to send the optimization rules. This configuration makes it possible to execute the promotion of the job executing server or the application server within itself, thereby making the process faster.

For example, if the job executing server or the application server requests the fast process, the optimization rules may be sent thereto, while if it does not request the fast process, the decentralized system managing server is served to send the control command. This configuration makes it possible to provide the economical decentralized system circumstances.

Application programs 212 and 213 execute the other processes. In addition, the log detecting process 206, the log data extracting process 207, the working process 208, the analyzing process 209, the execution rule generating process 210, and the optimization executing process 211 may be executed in respective programs as described above or collectively as one program. Each process will be described below.

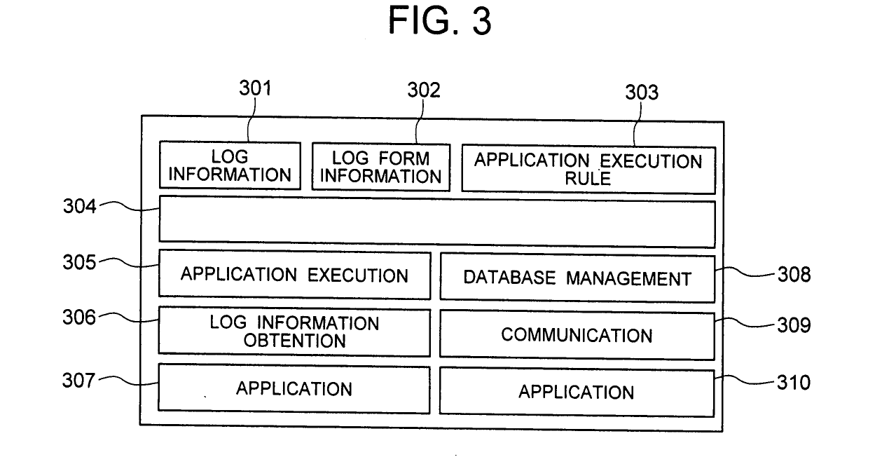

FIG. 3 shows the main data or program stored in the storage unit of the application server. The log information 301 includes the log information of the application server. The log form information 302 includes the log form information for defining the form of the log information. An application execution rule 303 stores the optimization rules sent from the decentralized system managing server 108. As described above, in the case that the control command is directly sent from the decentralized system managing server, the optimization rules are not necessarily required. An application executing process 305 is a program for executing the application based on the request sent from a client terminal to be connected with the application server. Concretely, the request sent from the client terminal is managed in correspondence with the application to be executed so that the corresponding application may be executed in response to the request. A database managing process 308 is a program for generating a processing command for the database to the job executing server in the case of storing the data in the database, updating the data, and reading the data. The database managing process 308 may execute the process in response to the request sent from the application program. A log information obtaining process 306 is a program for storing the commands executed by the application server as the log information in the log information 301 or sending the log information or the log form information based on the request sent from the decentralized system managing server 108. A communicating process 309 is a program for communicating with another application server, the job executing server, the decentralized system managing server, and the like. Numerals 307 and 310 are application programs for executing the processes in response to the request sent from the client. The other data is stored in the unit 304.

The application server is served to output the log being processed as the log information according to the predetermined log form information.

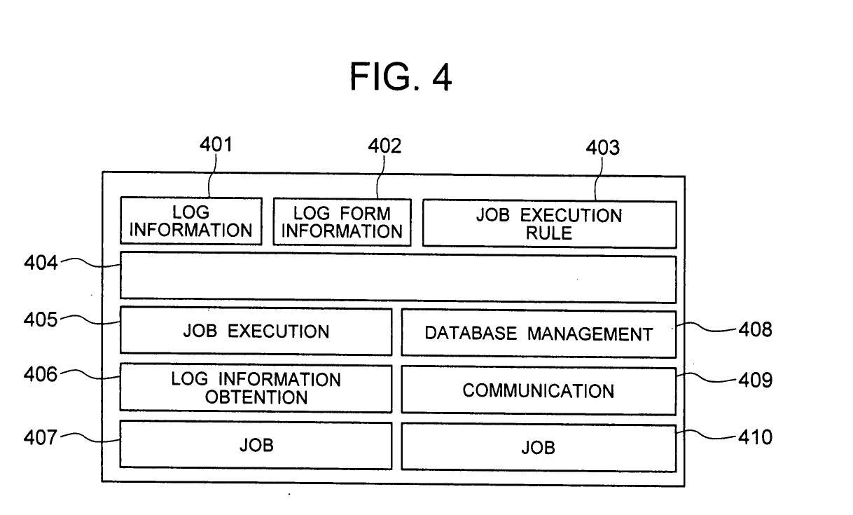

FIG. 4 shows the main data or program stored in the storage unit of the job executing server.

A log information 401 stores the log information of the job executing server. A log form information 402 defines the form of the log information. A job execution rule 403 stores the optimization rules sent from the decentralized system managing server 108. As described above, if the control command is directly sent from the decentralized system managing server, the optimization rules are not necessarily required. A job executing process 405 is a program for executing a job based on the request sent from the application server. Concretely, the job to be executed is managed in correspondence with the request sent from the application server so that the corresponding job may be executed in response to the request. A database managing process 408 is a program for storing data in the database, updating the data, and reading the data. A log information obtaining process 406 is a program for storing the commands and the like executed by the job executing server as the log information in the log information or performing a process for sending the log information or the log form information based on the request sent from the decentralized system managing server 108. The communicating process 310 is a program for communicating with another application server, the job executing server, the decentralized system managing server or the like. Jobs 407 and 410 are job programs for executing the process in response to the request sent from the application server. Further, the other data is stored in the unit 404. The job executing server is served to output the log being processed according to the predetermined log output form setting information.

In turn, the description will be oriented to the process of the decentralized system managing server 108.

At first, the log detecting process 206 of obtaining the log information from the server will be described. The log detecting process is composed of two subprocesses of generating the list for obtaining the log information and obtaining the log information according to the list.

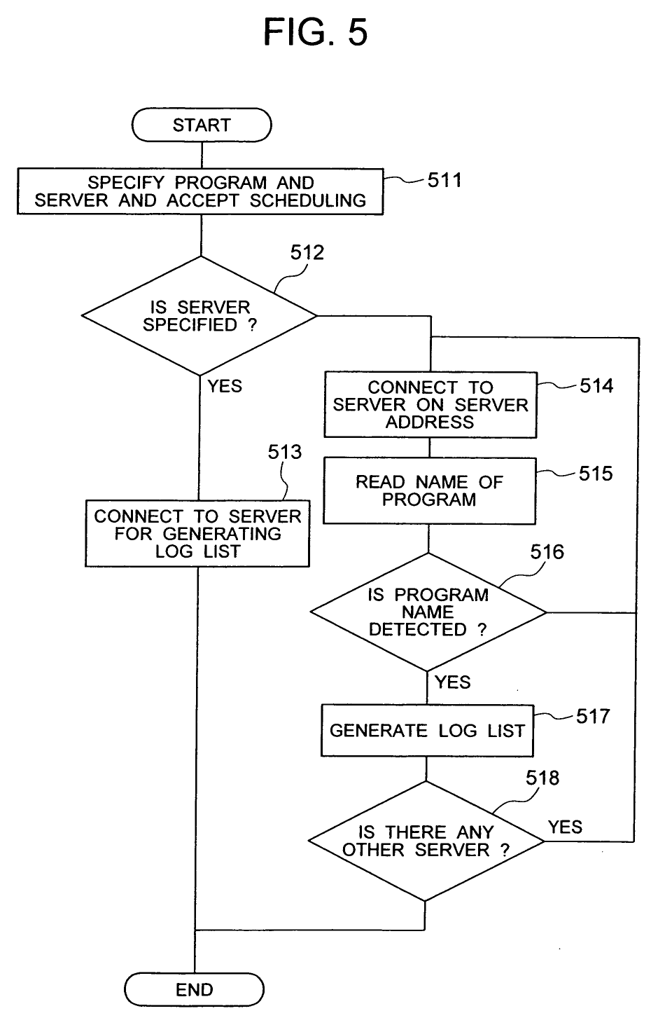

FIG. 5 shows a process of generating the list, which is used for collecting the log information.

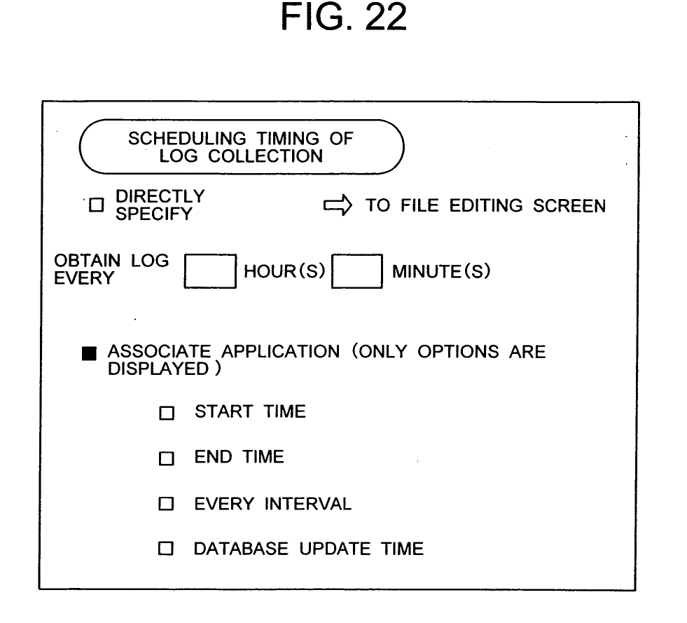

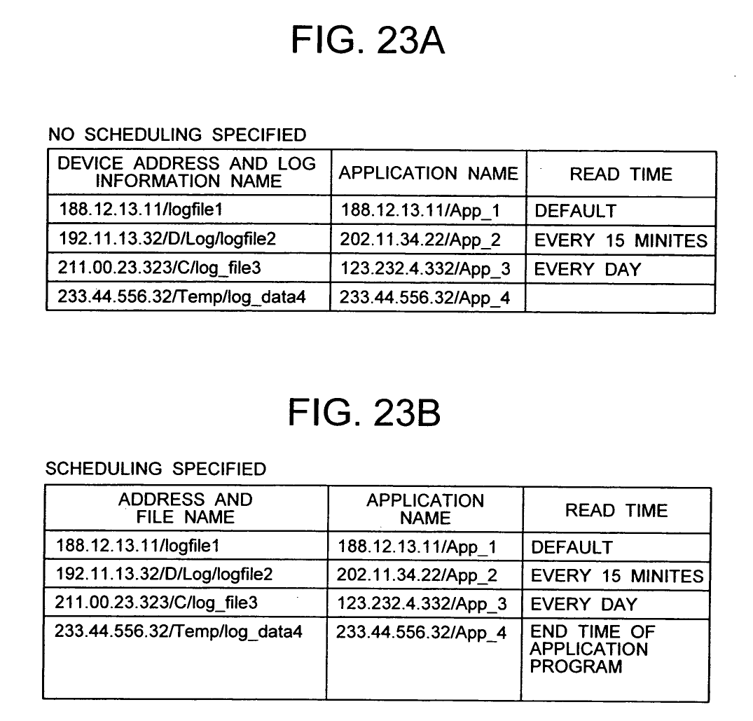

A process 511 is executed to accept a name of a program to be obtained as the log information, a specified server where the program is to be executed, and a schedule that indicates a time of collecting the log information. A process 512 is executed to determine whether or not the server is specified. If the server is specified, a process 513 is executed to connect to the specified server, obtain the location of the log information from the server, and then generate the log list (see FIG. 23). If no server is specified in the process 512, the process is executed to connect to the server according to the server address. If the program name is read out of the server connected in the process 515 and coincides with the specified program name, a process 517 is executed to obtain the location of the log information of the program name from the server and then generate the log list (see FIG. 23). Then, if a process 518 is executed to determine there is left one or more unconnected servers in the server address, the process goes back to the process 514. Further, if a process 516 is executed to determine that no matched program name is left, likewise, the process goes back to the process 514. As described above, these processes 514 to 518 are executed sequentially along the servers registered in the server address.

In generating the log list in the processes 513 and 517, if the schedule is specified, the location of the log information is written in the log list.

Herein, in the job executing server and the application server, the storage unit stores the program name in correspondence with the log information of the program and the storage location (address or file name) of the log form information. If the request for the program name is accepted from the decentralized system managing server, the list of the program names stored in the storage unit is outputted. Further, in the case of accepting the request for the storage locations of the log information and the log form information from the decentralized system managing server 108, the storage locations of the log information and the log form information are outputted.

FIG. 23 shows an example of the log list. As shown in FIG. 23, the list is generated from the address of the server, the log information name, the corresponding application name, and the read time. Herein, the read time means the accepted time of the schedule. If no schedule is accepted, a default is set. The decentralized system managing server is served to obtain the log information from each server based on this list. Herein, it is illustrated that the storage location of the log information is a file name. In place, it may be an address at which the log information is stored. That is, what is required is that the decentralized system managing server 108 enables to collect the log information later.

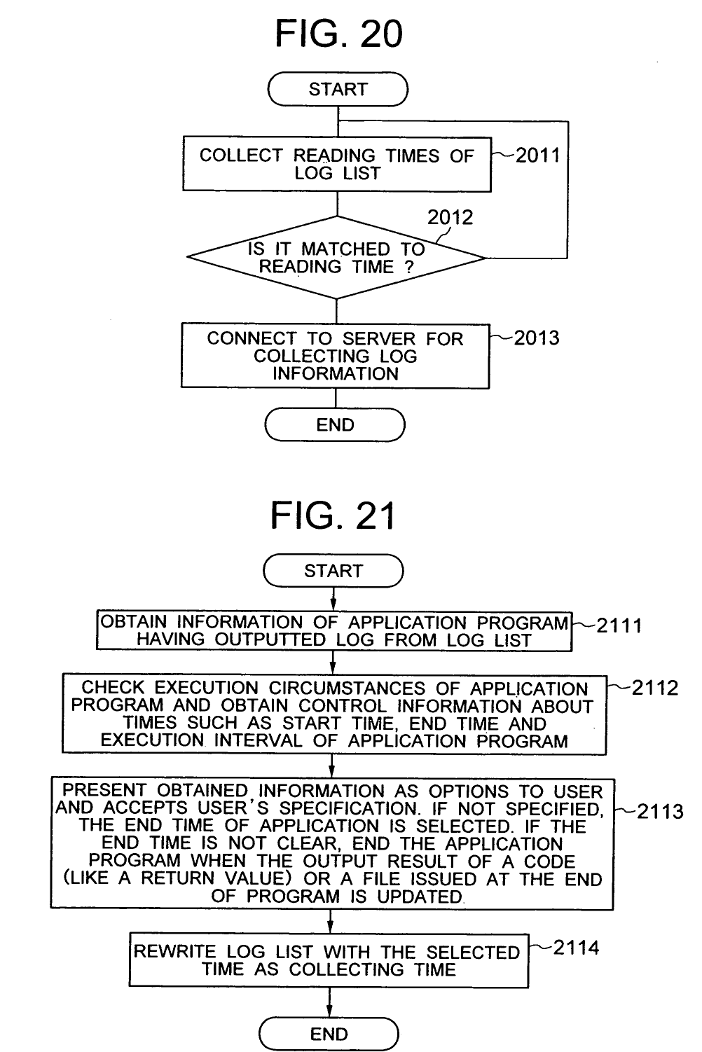

FIG. 20 shows the process of obtaining the log information. A process 2011 is executed to collect the read times of the log list. If the read time is matched by the time located in the decentralized system managing server (2012), an access is made to the server according to the log list and then the log information is collected (2013). If the read time is not matched, the log list is read again. If the read time is default, the log information is obtained at a time interval set by the decentralized system managing server 108. At a default time, it is possible to set the process so that no log information can be obtained.

As described above, the log information is collected at the time interval of the read time set in the log list. This read time may be changed. In this change, the read time may be inputted as it is or the read time may be determined by the scheduling process indicated below.

FIG. 21 shows a flow of the scheduling process. A process 2111 is executed to obtain the information of the application program that has outputted the log from the log list. A process 2112 is executed to check the application program execution circumstances based on the obtained application program information and obtain the control information about the time like the start time, the end time and the execution interval of the application program. For example, the circumstance variable of the device where the application program is executed is obtained by an env command. The circumstance variable can be obtained by reading the set times like a start time, a stop time, and an interval. The information (start time, end time, execution interval) obtained in the process 2113 is presented to the user as an option and then the user's specification is accepted.

An example of presenting to the user is illustrated in FIG. 22. This example indicates that the case that the log is obtained on the time specified by the user, the case that the collecting time of the log list is specified after being edited, and the case that the log is obtained in association with the control information of the application. In FIG. 22, the log obtention is illustrated at the end time of the application. A process 2113 is executed to select the association with the application. If no obtained time is specified, the process is executed to select the end time of the application. If the end time is not clear in advance, the time when updated is the output result such as a code (return value) or a file issued at the end of the program is regarded as the end time. The time selected in the process 2114 is regarded as the log information collecting time and the log list is rewritten. Then, the process is terminated. In addition, it holds true to the job program.

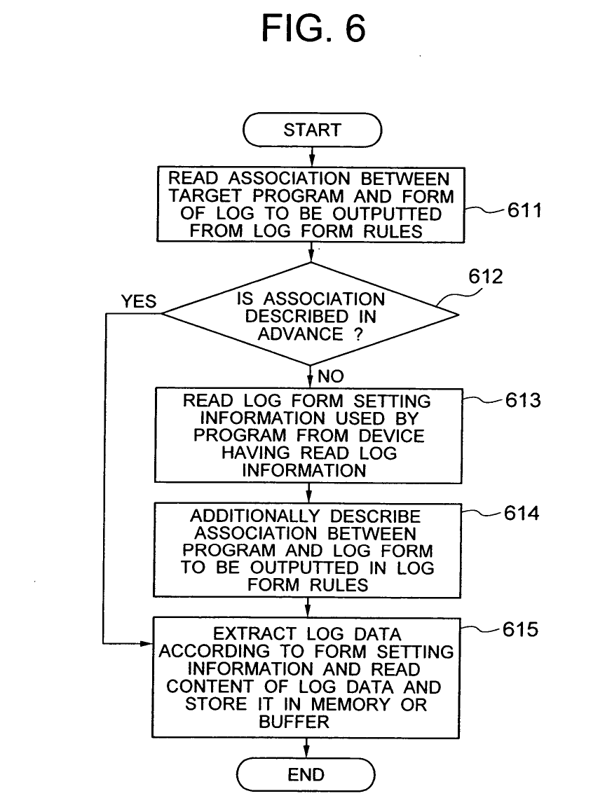

FIG. 6 shows a flow of the log data extracting process 207.

This process is a process of extracting the necessary log data from the log information collected for creating the promotion rule.

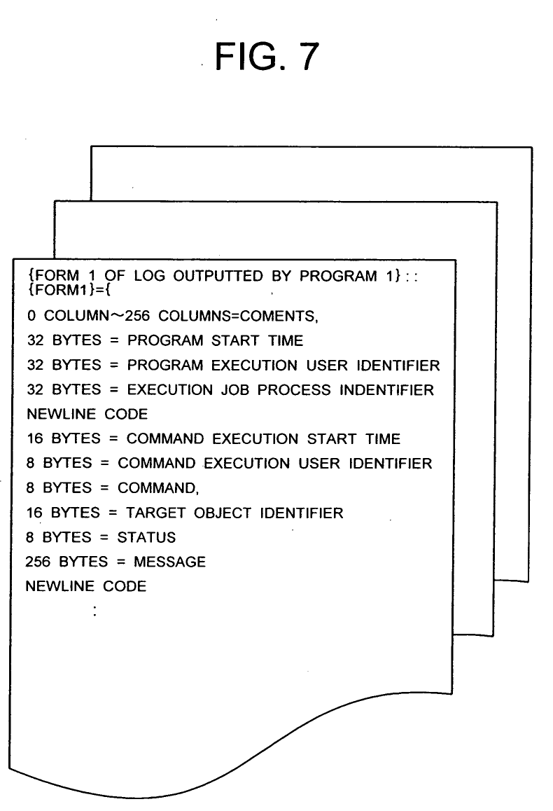

The association between the program to be processed in a process 611 and the form of the log to be outputted from this program is read from the log form rule (see FIG. 7). A process 612 is executed to determine if the relation between the log information and the form is described in advance. If no relation is described, the log form setting information to be used by the specified program is read from the server from which the log information has been read 613. The relation between the program obtained in the process 613 and the log form to be outputted is added to the log form rule (614). Then, the log data is extracted from the log information according to the log output form setting information and the content is read and stored in a memory or buffer (615). Further, if the relation is described in advance in the process 612, the process goes to the process 615 in which the data read is started.

FIG. 7 shows an example of the log form rule. Herein, for example, the form of the log to be outputted by a program 1 is called a form 1. The form 1 indicates the sequence of comments in the first 0 to 256 columns, a program start time in the next 32 bytes, a program execution user identifier in the next 32 bytes, an execution job process identifier in the next 32 bytes, a newline code, a command execution start time in the next 16 bytes, and so forth.

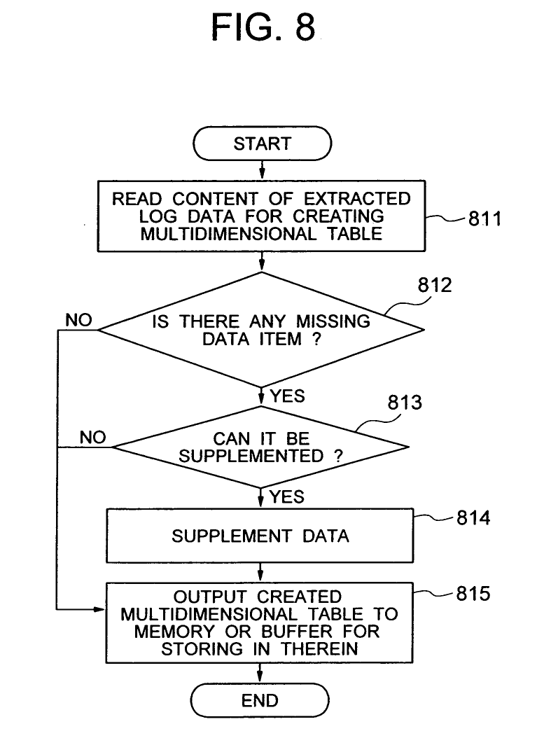

FIG. 8 shows a flow of a working process 208.

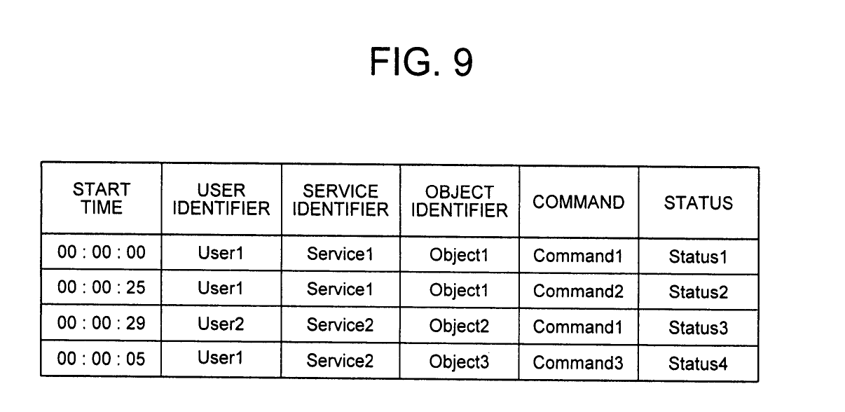

A process 811 is executed to read the content of the log data extracted in the process 203 and then create a multidimensional table (see FIG. 9).

FIG. 9 shows an example of the created multidimensional table. In this example, the multidimensional table is created to have a start time, a user identifier, a service identifier, an object identifier, a command, and a status as data items.

A process 812 is executed to determine if any missing data item is in the created multidimensional table. If yes, a process 813 is executed to determine if it is to be supplemented. If yes, a process 814 is executed to perform the data supplementation. For example, if a service identifier is missing in a certain row, the same command and the same object identifier are retrieved by referring to another multidimensional table. If the same command and object identifier are given, the service identifiers thereof are supplemented. By referring to another multidimensional table having executed the same service, it is possible to make sure of whether or not no missing is in a series of processes. Based on the result, the supplementation can be executed.

The multidimensional table created as described above is outputted to and stored in the memory or buffer (815). If no data item is missing or the supplementation is disabled, the process goes to the process 815 as it is.

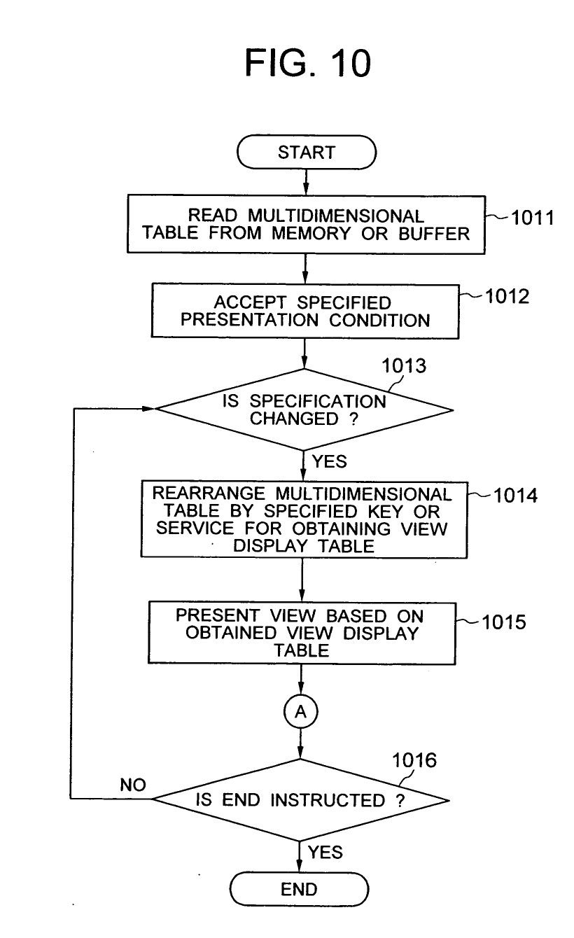

FIG. 10 shows a flow of the analyzing process 209.

A process 1011 is executed to read the multidimensional table from the memory or the buffer. Then, a process 1012 is executed to accept the specification of the presentation condition.

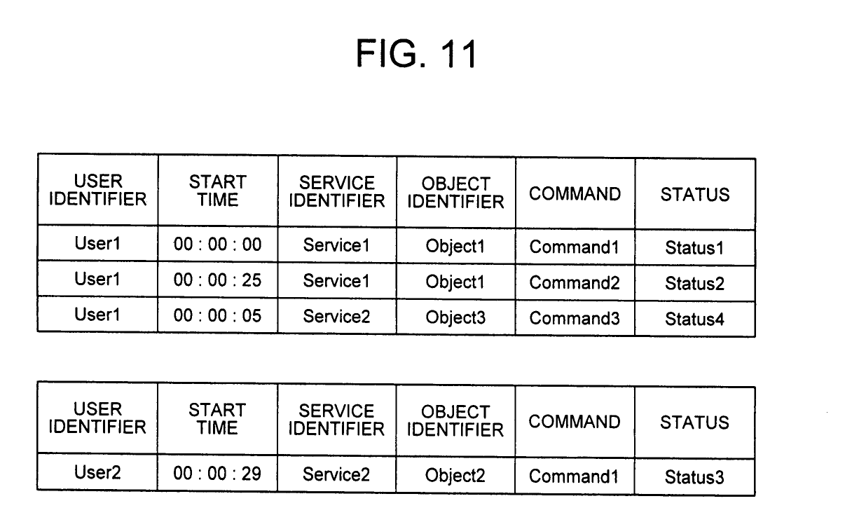

In place of accepting the specification, this presentation condition may be preset. If the specified presentation condition is changed (1013), the use of a specified key or service makes it possible to rearrange the multidimensional table, thereby obtaining a view display table (see FIG. 11) (1014). Based on the obtained view display table, the analyzed view is presented (1015). This analyzed result is displayed by executing the corresponding application. In addition, the process A is a process of creating the optimization rules to be discussed below. Until the end is indicated, the specification of the presentation condition of the view is continuously accepted, and the processes 1013 to 1016 are repeated.

FIG. 11 shows an example of the view display table. This view display table indicates that the specified key was a user identifier.

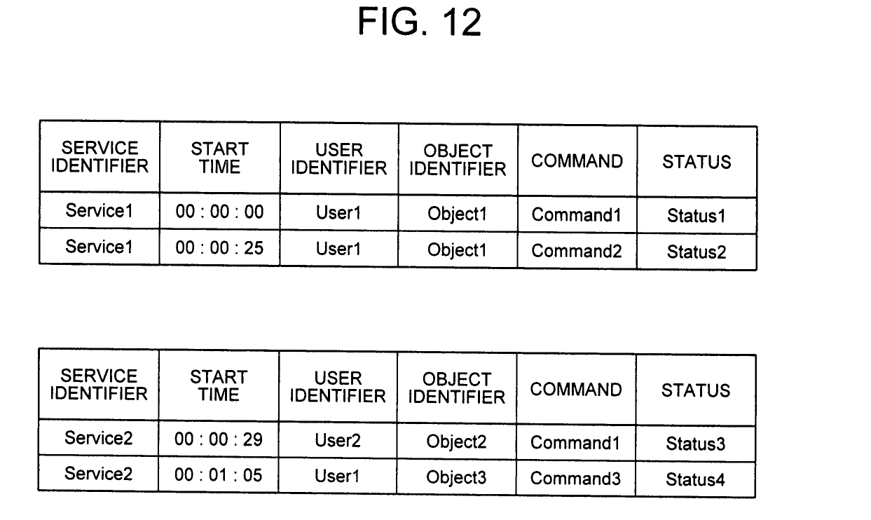

FIG. 12 shows another example of the view display table. This view display table indicates the table rearrangement specified by the service. In addition, the service contains a process done by one application and another process done by a plurality of applications.

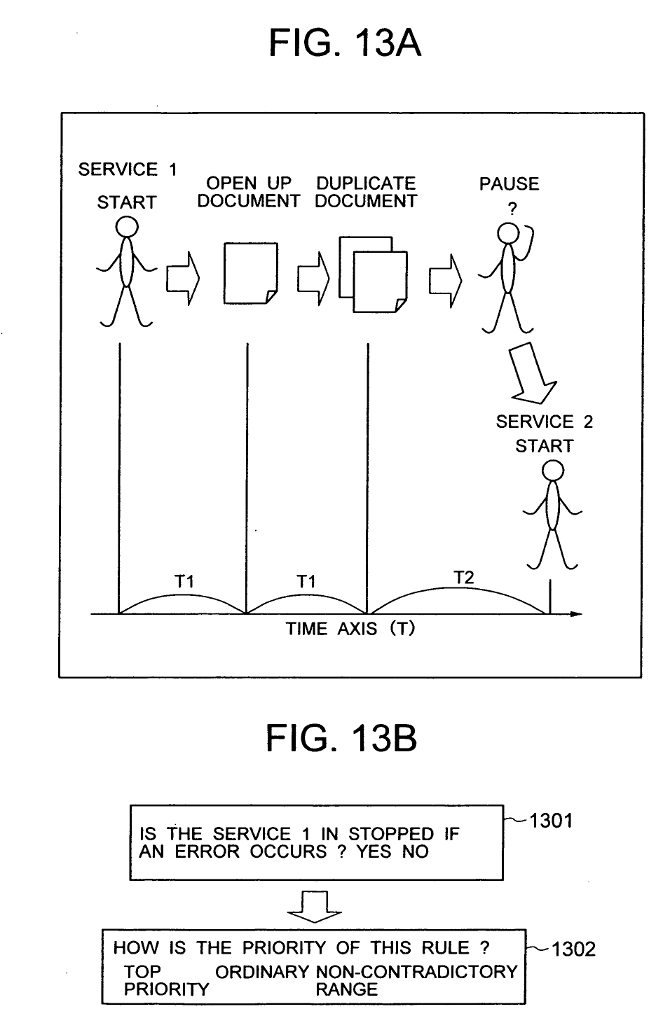

FIGS. 13 to 16 show an example of a view displayed in the process 1015.

FIG. 13A shows an exemplary user's operation history. The display shown herein indicates that the specified condition is the “user, history”. The view display table is generated by the user that is the specified condition. Further, by the history that is also the specified condition, the application program for displaying the time and the command of the view display table in a graph is selected and displayed.

This operation history indicates the following operations. The user starts the service 1. After a series of operations including “opening a document” and “duplicating a document” is carried out, an error takes place. The operation is stopped for a while. Then, the user starts the service 2.

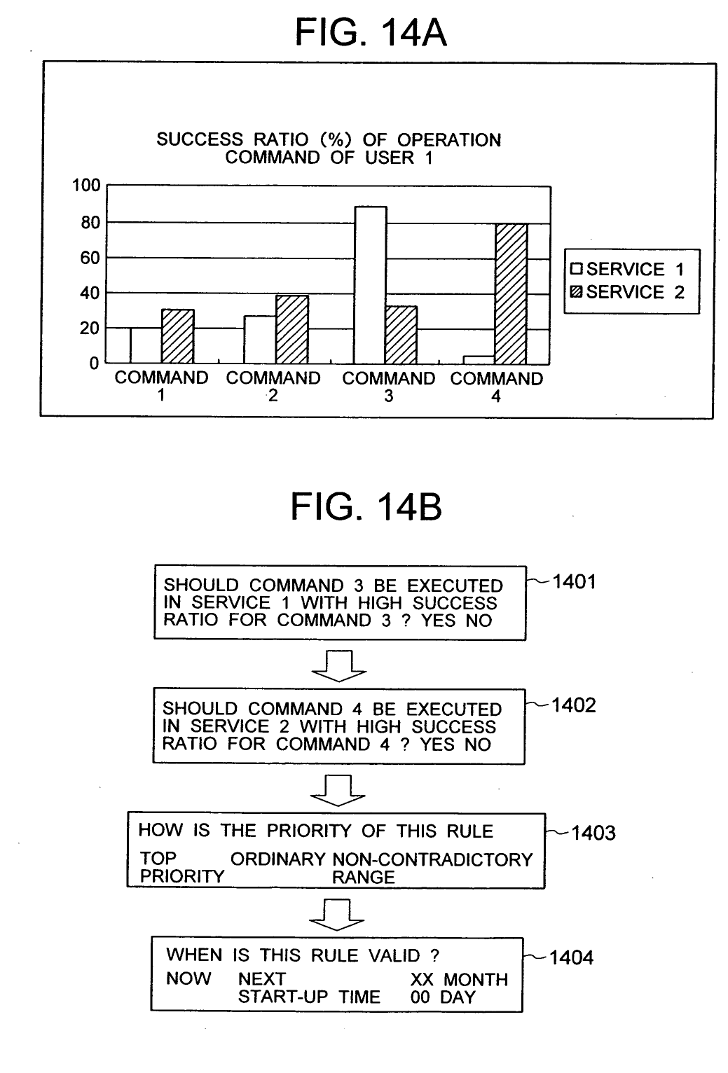

FIG. 14A shows an accumulative success ratio (%) of the user's operation command.

The display example shown in FIG. 14A indicates that the specified condition is “command, service, accumulation”. The view display table is generated with the command that is the specified condition as a first priority and the service as a second priority. Further, with the accumulation that is the specified condition, the use of the command and the service of the view display table makes it possible to select and display the application program for displaying the graph.

This graph indicates that as to the command 3, the user has a high success ratio in the service 1, while as to the command 4, the user has a high success ratio in the service 2.

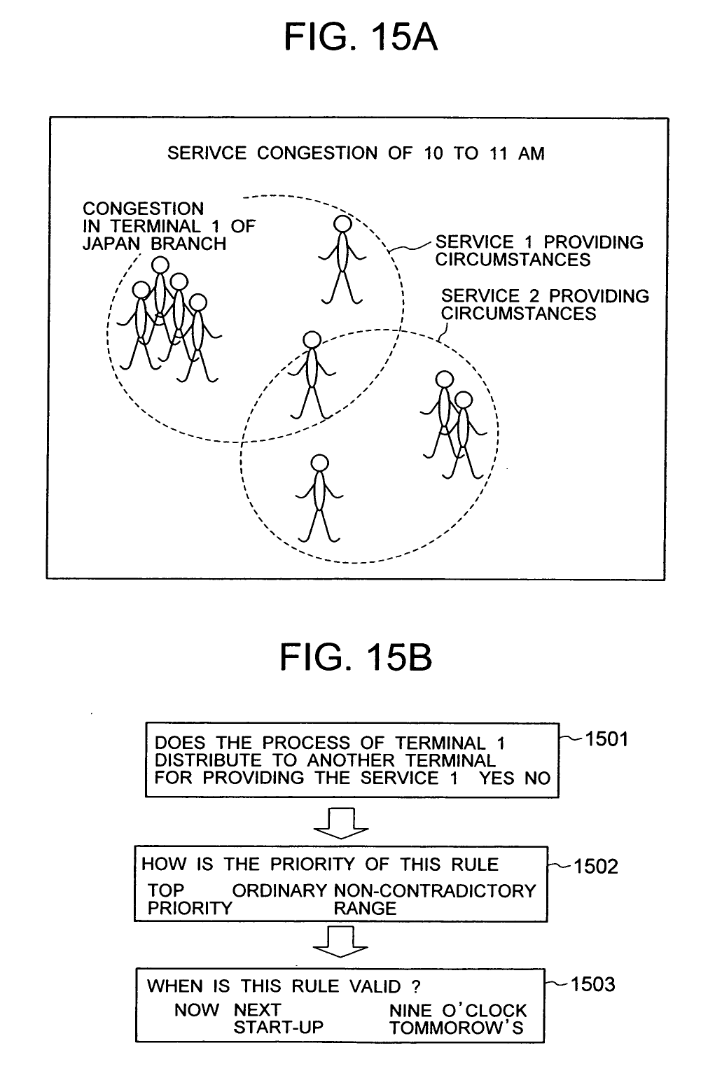

FIG. 15A shows a congestion ratio of services on a certain time band. Herein, the display example herein is that the specified condition is “time band, service, and accumulation”. The view display table is generated with the time that is the specified condition as the first priority and the service as the second priority. With the accumulation that is the specified condition, an application program is selected and displayed for displaying a relation between a user's access number and a service on a time band specified by the view display table.

Herein, the congestion ratio is displayed by the number of persons. The display indicates that the terminal 1 at the Japan branch that provides the service 1 is congested more than the other terminal.

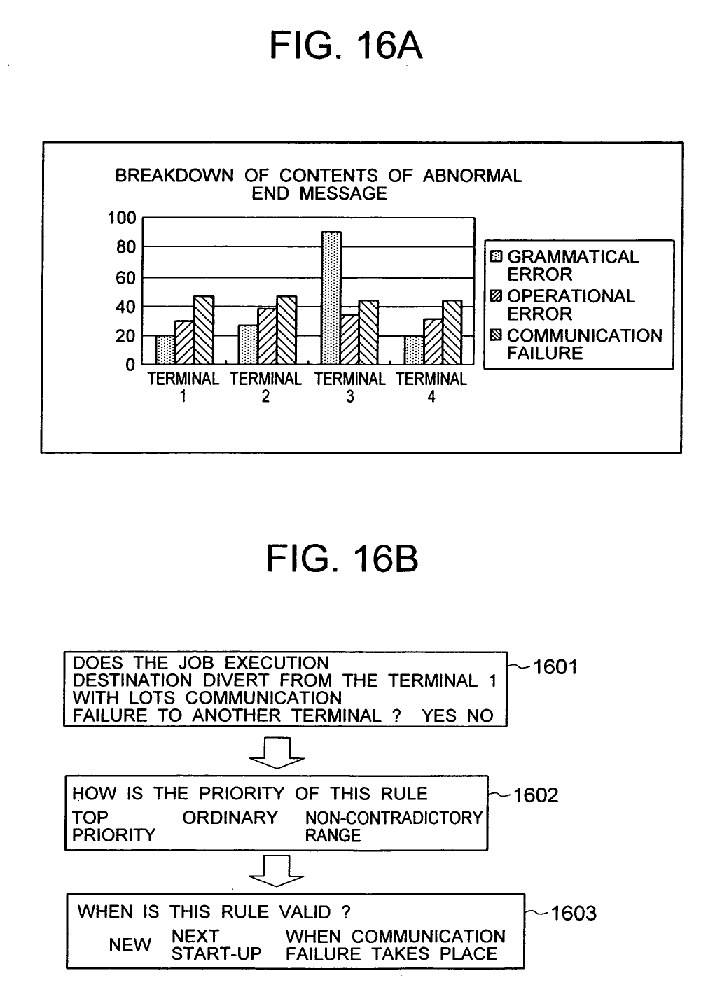

FIG. 16A shows the content breakdown (%) of the message of an abnormal end message. The display herein indicates that the specified condition is “error, terminal and accumulation”. The view display table is generated with the error (status in the view display table) that is the specified condition as the first priority and the terminal as the second priority. With the accumulation that is the specified condition, an application program for displaying a relation between the specified status and the terminal of the view display table is selected and displayed.

In this example, it is indicated that the terminal 1 at the Japan branch has a higher ratio in abnormal end by communication failure.

For performing the view display, as described above, the application program for the view display is prepared so that the presentation condition given by the user may be associated with the application program. This makes it possible to display various kinds of views.

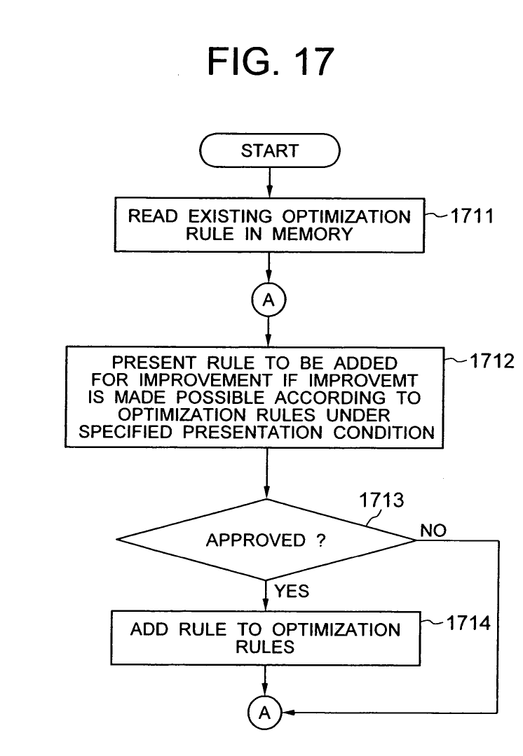

FIG. 17 shows a flow of a process 210 of generating an execution rule.

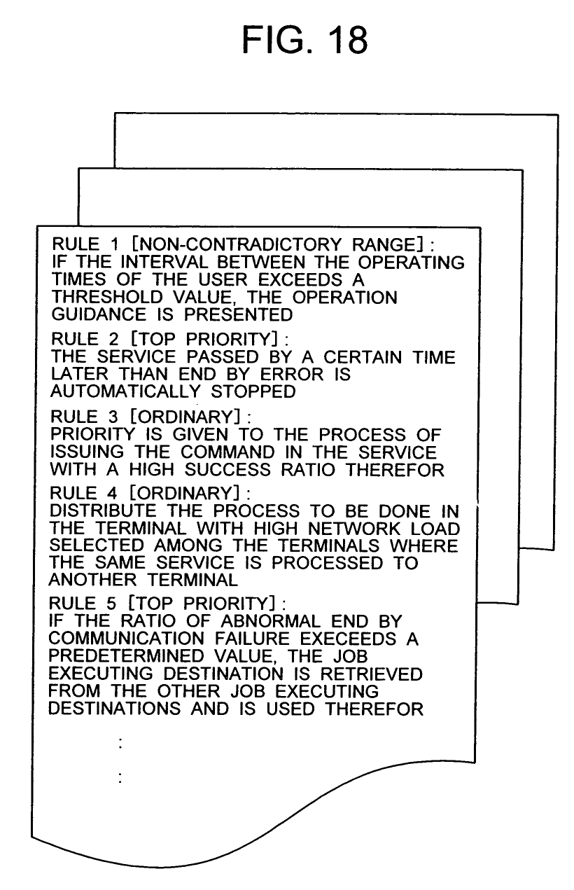

If any existing optimization rule (see FIG. 18) exists, the rule is read in a memory (1711). Next, in the analyzing process (209) (the portion indicated by “A” in FIG. 18), under the specified condition, if improvement is made possible according to the optimization rules, the addition of the rule for improvement is presented (1712). It is determined if the presented additional rule is approved (1713). If it is approved, the rule is added to the optimization rules (1714). Then, the process goes back to the analyzing process. If it is not approved, the process goes back to the analyzing process without adding it to the optimization rules.

In turn, the description will be oriented to the creation of the optimization rules with reference to FIGS. 13 to 16 and FIGS. 24 to 27.

In the process shown in FIG. 13A, after an error takes place in the service 1, the user changes the service 1 to the service 2 in which the operation is continued. The service 1 is continued as keeping the error occurring. FIG. 13B shows an exemplary display of the screen on which the rule for stopping the process is set. At first, the process is executed to display a content where an inquiry appears as to whether or not the rule for stopping the service 1 is added (1301). If “yes” is selected, there is displayed a content where a priority is asked if that rule is added to the optimization rule (1302). The rule added by this display is shown in the rule 2 of FIG. 18. The rule 2 defines a message “a certain length of time later than the end by error the service is automatically stopped. Further, this rule is defined to be processed at a top priority.

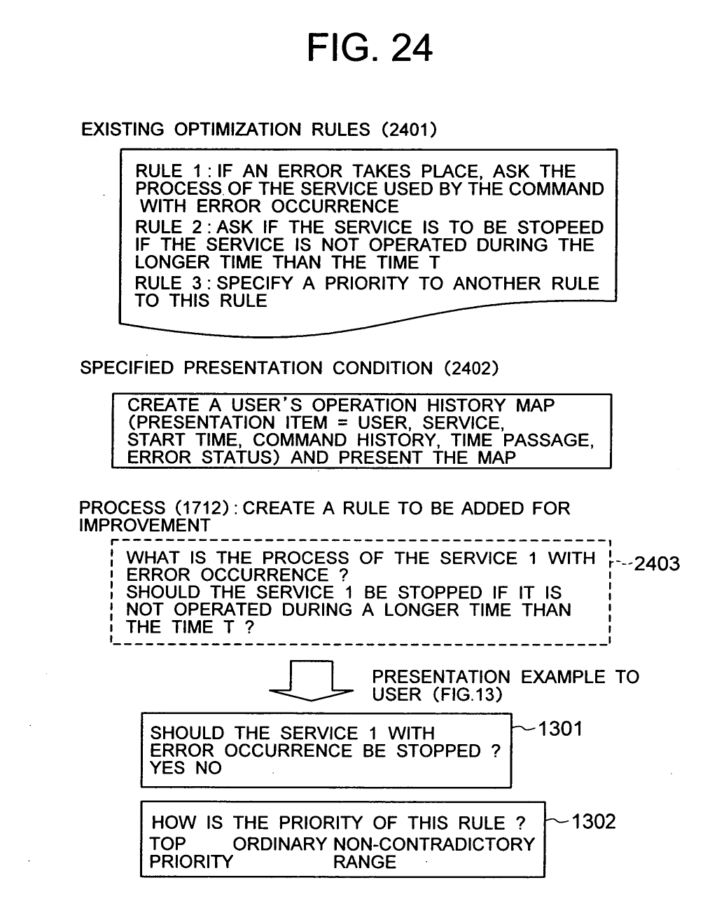

FIG. 24 illustrates a system of creating the rule 2 shown in FIG. 18. The existing optimization rule (2401) indicates the most initial state of the existing optimization rule read in the process 1711. This has been predetermined by the system or the user. In place, the system may provide a generally versatile rule, which may be then customized by the user. As described above, the predetermined optimization rule is compared with the condition 2402 presented in the analyzing process 209 for creating a plan 2403 of the rule to be added. For example, in the case shown in FIG. 13A, the error occurrence in the service 1 can be obtained as a result of analyzing the log information. Hence, the rule 1 of the existing optimization rules shown in FIG. 24 is selected.

The messages presented as the above to the user are indicated by 1301 and 1302 of FIG. 13B. When the added rule is approved by the user, it is added to the optimization rule 1801 and the optimization rule 1801 is updated. As described above, the optimization rule 1801 is likely to include the fine rule settings. In addition, as to the optimization rule 1801, the user may directly perform an inputting and editing operation.

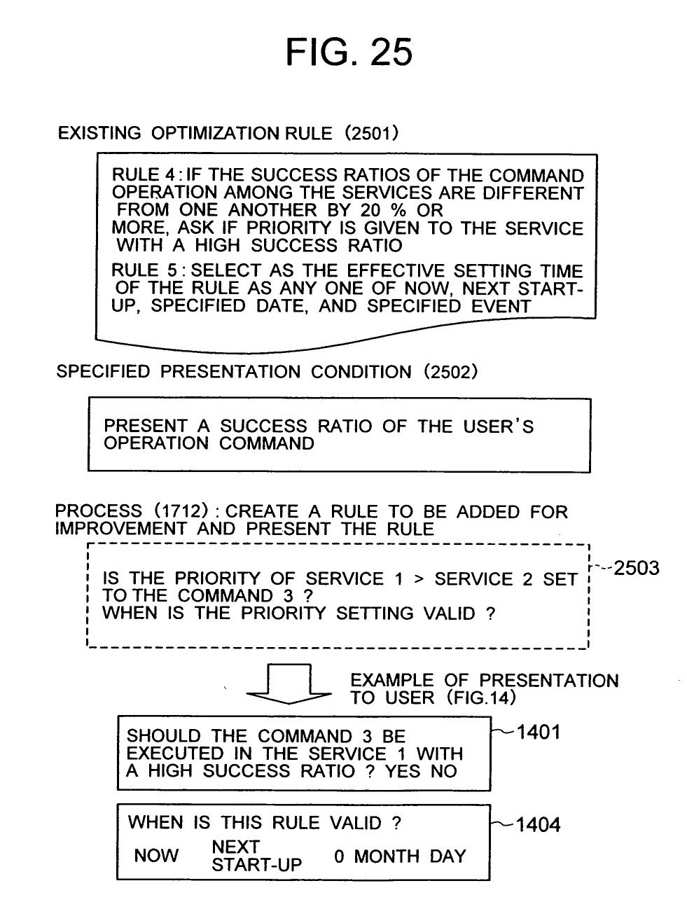

Likewise, in the example shown in FIG. 14B, it is checked if the two processes 1401 and 1402 are added to the rule. The process 1401 is executed to give priority to the command 3, that is, perform the command 3 in the service 1 with a high success ratio. The process 1402 is executed to give priority to the command 4, that is, perform the command 4 in the service 2 with a high success ratio. The priority of the rule is specified (1403). The rules added in the processes 1401 to 1403 are indicated in the rule 3 of the optimization rules 1801. At a time, a system of creating and presenting an improving rule in the process 1712 is illustrated in FIG. 25.

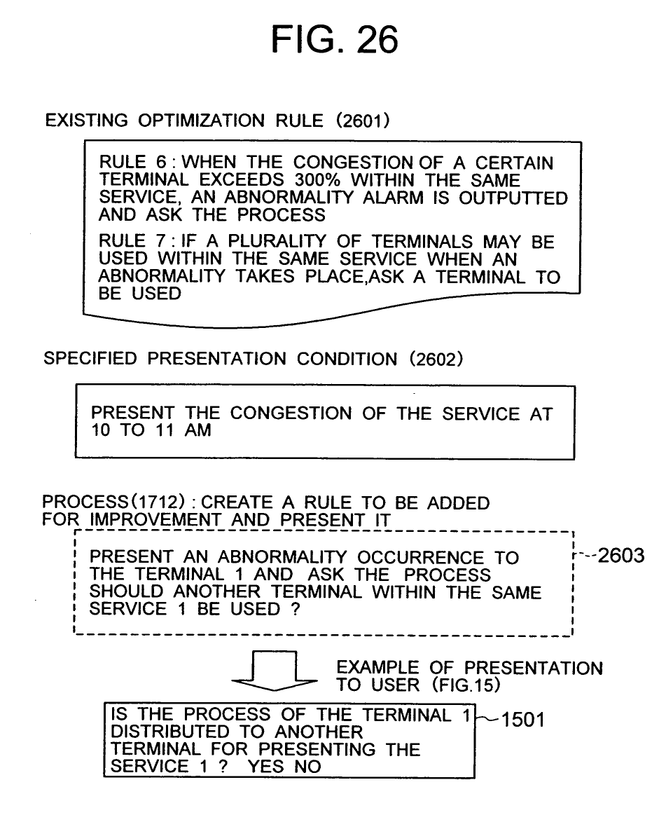

In the example shown in FIG. 15B, in the process 1501, it is checked if the process of the terminal 1 is distributed to another terminal having presented the service 1. In the process 1502, the priority of the rule is checked. As a result of doing the processes 1501 and 1502, the added rule is indicated to the rule 4 of the optimization rules (1801). At a time, a system of creating and presenting the improving rule in the process 1712 is illustrated in FIG. 27.

Based on the optimization rules created as above, the optimization instruction for controlling the promotion of the service is generated and issued.

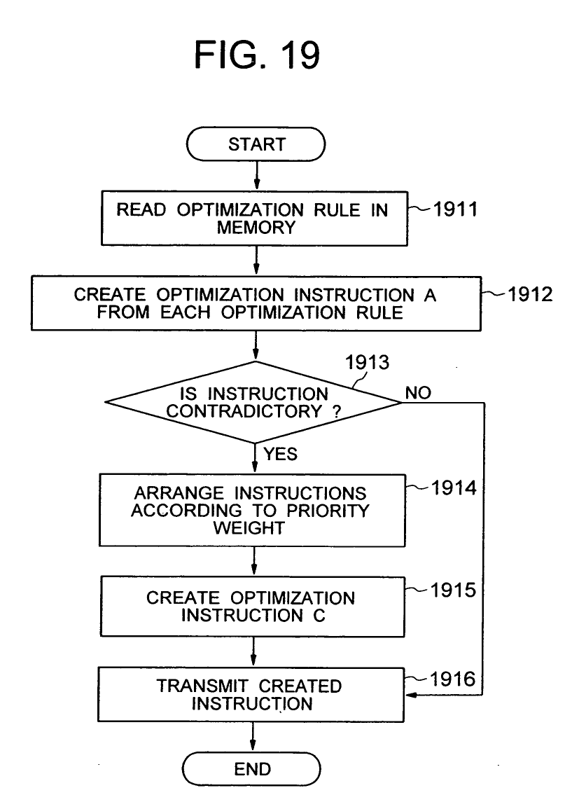

FIG. 19 shows a flow of the optimization executing process 211 of creating and issuing an optimization instruction for controlling the promotion of the server.

At first, in a process 1911, the optimization rules are read in the memory. Then, an optimization instruction a (control command) to be executed by the job executing server and the application server is created from each of the optimization rules (1912). For example, the optimization instruction a includes a command for stopping the application, another command for executing a job at a priority, or the like. This control command is associated with the optimization rule. The optimization instruction a is created by reading the command from the selected optimization rule. In addition, the optimization rule and the command may be optionally added.

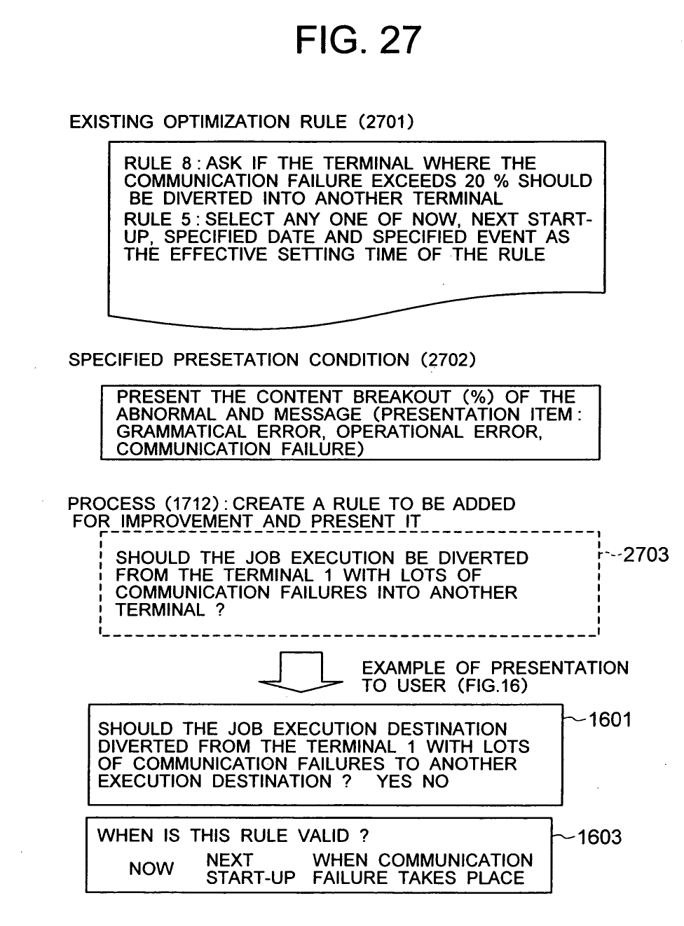

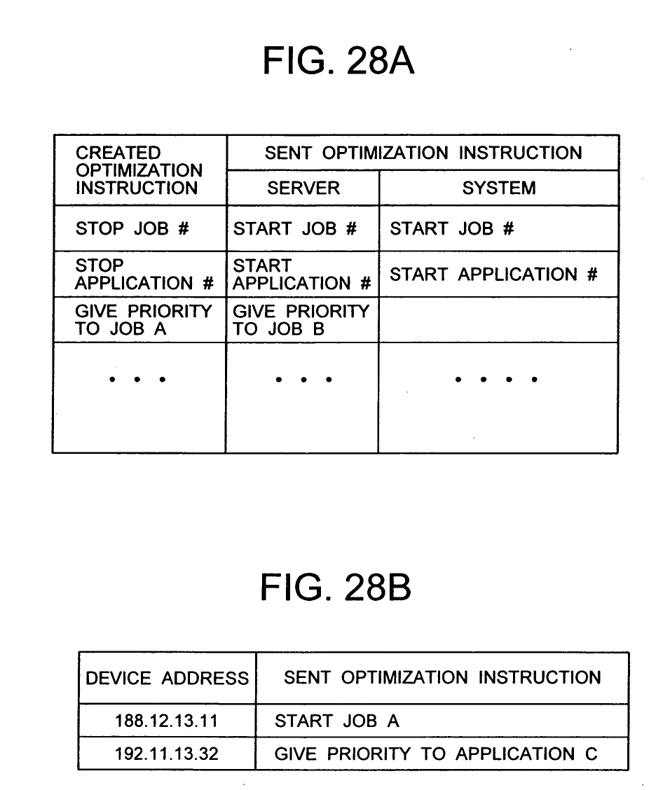

Then, it is checked if the created optimization instruction a includes a contradictory point (1913). One contradictory point is that if the optimization instruction for executing Job A at a top priority has been already sent to the job executing server, the optimization instruction for executing Job B at a top priority is created. Further, another contradictory point is that the optimization instruction for stopping Job A and the optimization instruction for starting Job A are created at a time. In order to avoid such cases, such a table as shown in FIG. 28A is created. The optimization instructions that are not permitted to be provided at a time are associated with each other. Herein, “#” signifies that it coincides with the content of the created optimization instruction. For example, if the created optimization instruction a indicates “Job A is stopped”, “#” of “Job #” start” in the columns of the server and the system is made to be “A”. Hence, it is understood from this table that no “stop Job A” and “start Job A” are provided at a time.

The “server” column of the table corresponds to the server to which the created optimization instruction a is to be sent. The “system” column corresponds to an overall server to be connected with the decentralized system managing server. For example, if the optimization instruction a for “stop Job A” is created, it indicates that this optimization instruction a and the optimization instruction b for “start Job A) are not located in the same server. At a time, it indicates that the optimization instruction b for “start Job A” and the optimization instruction a for “stop Job A” are not located in the overall server to be connected with the decentralized system managing server. It indicates that if the optimization instruction b for “start Job A” is located in any one of the servers included in the system, the optimization instruction a for “stop Job A” is not issued.

On the other hand, the decentralized system managing server stores the optimization instruction sent to each server as shown in FIG. 28B. For example, in FIG. 28B, the optimization instruction b for starting Job A is issued to the server. Hence, it is understood from FIG. 28A that the optimization instruction a for stopping Job A is not allowed to be sent to the job executing server 104. In a process 1912, therefore, if the optimization instruction a for stopping Job A is created, it is determined that a contradiction takes place in a process 1913.

If a contradiction takes place, the instruction is arranged according to the priority weight of the rule (1914). That is, starting Job A or stopping Job A is determined according to the priority weight. The priority weight has been already inputted as shown in FIGS. 13 to 16 and thus is used for that determination. According to the determined priority, a process (1915) is executed to create an instruction for giving the optimization instruction c to the target job executing server and application server. In the previous example, the optimization instruction a for “stop Job A” is created. If the optimization instruction a for “stop Job A” is at a higher priority than the already issued optimization instruction b for “start Job A”, a new optimization instruction c for deleting the optimization instruction b for “start Job A” is created. By sending the new optimization instruction c to the server, the optimization instruction b for “start Job A” is deleted. Afterwards, by sending the already created optimization instruction a for “stop Job A”, Job A can be stopped.

The created optimization instruction a and optimization instruction c are issued to the job executing server and the application server through the network (1916). As to the optimization instruction c, if the optimization instruction b is described in the server column of the table shown in FIG. 28A, the optimization instructions a and c are sent to the same server. On the other hand, if the optimization instruction b is described in the system column of the table shown in FIG. 28A, the optimization instruction c is sent to the server to be connected with the decentralized system managing server.

If it is determined that the created optimization instruction a is contradictory to the optimization instruction b that has been already sent and the created optimization instruction c is at a lower priority than the optimization instruction b, the created optimization instruction c is not issued. Further, the issuing timing can be specified. For example, the decentralized circumstances with a time lag make it possible to issue the instruction within the safe time for the service. Moreover, the overall process of the decentralized system managing server (108) may be carried out by the batch process so that no substantial load may be burdened in the system in managing the servers. As an example, the job executing server has been described. Likewise, the optimization instruction is issued to the application server. As described above, the process of generating an execution rule is executed to issue the control command for controlling the server on the basis of the promotion rule. This makes it possible to efficiently promote the overall system. Further, the decentralized system managing server enables to register the commands that are not allowed to be executed at a time. The process of generating the execution rule is executed to issue the optimization instruction so as to allow the command to be executed to be left. This makes it possible to efficiently promote the server or the overall system.

As set forth above, in this embodiment, if a plurality of promotion rules for defining promotion of the service and an executing condition for each promotion rule are set, the log information created by executing the service is collected from each server, and the collected log information meets the condition, the instruction is outputted for controlling the server based on the promotion rule associated with this condition. This makes it possible to divert the existing log information included by the existing application, analyze the status of the job execution in the decentralized circumstances, and thereby allow the user to grasp the status of the job execution without having to recreate the application.

The collection and the analysis of the log are carried out independently of the operation of the system. Hence, the optimizing process is allowed to be executed without having to give an adverse effect of the network load onto the system.

Further, the method of supporting management of the system is provided for carrying out the analysis of the history accumulated in the past and giving a proposal on improving the system on the analysis.

The present invention provides the circumstances of the efficiently promoted decentralized system.

What is claimed is:

1. A managing program of determining operation of a service in a system having a plurality of computers, each of said computers serving to execute the service, comprising:
pre-generating based on a user history a plurality of operation rules for defining operation of said service, said operation rule being generated by editing and analyzing log information generated by executing said service;
pre-generating based on a user history a plurality of conditions for executing said operation rules, respectively; and
wherein the log information generated by executing a command is collected from each of said computers and if said collected log information meets said condition, an instruction for controlling the service executed on said computer is outputted on the basis of the operation rule associated with said condition.
